(19) United States
(12) Patent Application Publication
(10) Pub. No.: US 2005/0083160 A1
(43) Pub. Date: Apr. 21, 2005

(54) Insulation system for oil filled environments

(75) Inventors: George Gao, Round Rock, TX (US); Cuve William Reed, Scotia, NY (US); Thangavelu Asokan, Bangalore (IN); Paul Alfred Siemers, Clifton Park, NY (US); Santanu Singha, Assam (IN)

Correspondence Address: Jean Testa, Esq.;GE Global Research Center, P.O. Box 8, Schenectady, NY, 12301, US

(73) Assignee: General Electric Company

(21) Appl. No.: 10/686,290

(22) Filed: Oct. 15, 2003

(51) Int. Cl. H01F 27/10

(52) U.S. Cl. 336/58

(57) ABSTRACT

An insulation system for an oil filled environment having a plurality of insulating units, each of the plurality of insulating units including a first layer of insulating material and a second layer of insulating material. At least one of the first and second layers includes a polymeric material. The insulating units are positioned with respect to each other such that the second layer of one insulating unit is adjacent to the first layer of another insulating unit.

### BACKGROUND OF INVENTION

The present disclosure relates to insulation systems for oil filled environments. More particularly, the present disclosure relates to insulation systems for oil filled transformers.

Traditional oil-filled transformer designs use papers, such as cellulosic/aramid papers as layer and main insulation. The disadvantages of paper insulation systems include low dielectric strength, high thermal degradation, high shrinkage, and high water absorption. Due to these properties of paper insulation systems, transformer insulation must be designed at a low operating stress, which in turn results in larger transformer size and/or a large quantity of insulation materials. Large quantities of paper insulating materials add to the cost of manufacturing oil-filled transformers. Further, water content in paper insulation systems contributes to shorter lifespans due to more rapid degradation. To address the high water absorption of paper insulation, the manufacture of oil filled transformers involves drying steps that increase time and cost.

Accordingly, there is a need for insulation systems for oil-filled environments, such as oil filled transformers that have improved physical and electrical properties and thus could be used in smaller quantity to achieve similar performance as paper insulation materials or improve the service life.

### BRIEF DESCRIPTION OF THE INVENTION

The present disclosure provides an insulation system for an oil filled environment having a plurality of insulating units, each of the plurality of insulating units including a first layer of insulating material and a second layer of insulating material. At least one of the first and second layers includes a polymeric material. The insulating units are positioned with respect to each other such that the second layer of one insulating unit is adjacent to the first layer of another insulating unit.

The present disclosure also provides an oil filled electric device including an insulation system which includes a plurality of insulating units, each of the plurality of insulating units including a first layer of insulating material and a second layer of insulating material. At least one of the first and second layers includes a polymeric material. The insulating units are positioned with respect to each other such that the second layer of one insulating unit is adjacent to the first layer of another insulating unit.

The present disclosure further provides an oil filled transformer including: a main insulation which includes a plurality of insulating units, each of the plurality of insulating units including a first layer of insulating material and a second layer of insulating material. At least one of the first and second layers includes a polymeric material. The insulating units are positioned with respect to each other such that the second layer of one insulating unit is adjacent to the first layer of another insulating unit.

The present disclosure still further provides an insulation system for an oil filled environment which includes a first layer of a polymeric insulating material, said first layer being selected from the group consisting of layer insulation, main insulation, spacer insulation, end rings and any combinations thereof.

The present disclosure yet still further provides an insulation system for an oil filled environment which includes a plurality of layers of insulating material, at least two of the plurality of layers comprising a polymeric material.

### BRIEF DESCRIPTION OF THE DRAWINGS

FIG. 1 shows one example of an insulation system with a first layer and a second layer.

FIG. 2 shows one example of an insulation system with a plurality of insulating units and a third layer.

FIG. 3 shows an electrical winding with LV/HV/LV arrangement in a transformer.

FIG. 4 shows a close up view of the main insulation, LV winding, HV winding, and layer insulation.

FIG. 5 shows the AC Breakdown test results of different polymer films.

FIG. 6 shows the AC breakdown strength (Volts/mil) of various combinations of epoxy patterned kraft paper and Polyethylene Terephthalate (PET).

FIG. 7 shows the AC Breakdown Strength (Volts/mil) of QUIN-T and Polypropylene (PP) films at room temperature and at 90 degree Celsius.

FIG. 8 shows the AC Breakdown Strength (Volts/mil) of QUIN-T and Polypropylene ((PP) films in combination with epoxy patterned kraft paper at room temperature and at 90 degree Celsius.

FIG. 9a shows the variations of AC breakdown strength (kV/mil) as a function of the ratio of Polyethylene Terephthalate (PET) and epoxy patterned kraft paper at room temperature.

FIG. 9b shows the variations of AC breakdown strength (kV/mil) as a function of the ratio of Polyethylene Terephthalate (PET) and epoxy patterned kraft paper at 120 degree Celsius.

FIG. 10a shows the AC breakdown strength (kV/mil) as a function of polymer content (in percentage) in the combination of polyethylene Terephthalate (PET) and epoxy patterned Kraft paper at room temperature.

FIG. 10b shows the AC breakdown strength (kV/mil) as a function of polymer content (in percentage) in the combination of polyethylene Terephthalate (PET) and epoxy patterned Kraft paper at 120 degree Celsius.

### DETAILED DESCRIPTION OF THE INVENTION

In one aspect, the present disclosure provides an insulation system for an oil filled environment having a plurality of insulating units, each of the plurality of insulating units including a first layer of insulating material and a second layer of insulating material. At least one of the first and second layers includes a polymeric material. The insulating units are positioned with respect to each other such that the second layer of one insulating unit is adjacent to the first layer of another insulating unit.

In another aspect, the present disclosure also provides an oil filled electric device including an insulation system which includes a plurality of insulating units, each of the plurality of insulating units including a first layer of insulating material and a second layer of insulating material. At least one of the first and second layers includes a polymeric material. The insulating units are positioned with respect to each other such that the second layer of one insulating unit is adjacent to the first layer of another insulating unit.

In still another aspect, the present disclosure further provides an oil filled transformer including: a main insulation which includes a plurality of insulating units, each of the plurality of insulating units including a first layer of insulating material and a second layer of insulating material. At least one of the first and second layers includes a polymeric material. The insulating units are positioned with respect to each other such that the second layer of one insulating unit is adjacent to the first layer of another insulating unit.

In yet still another aspect, the present disclosure still further provides an insulation system for an oil filled environment which includes a first layer of a polymeric insulating material, said first layer being selected from the group consisting of layer insulation, main insulation, spacer insulation, end rings and any combinations thereof.

Electrical devices, such as oil filled transformers, typically are very expensive. Additionally, consumers of such devices, such as power utility companies, require long life spans that are often in the decades. Further, oil filled transformer technology has not changed dramatically for some time. Consumers of these costly devices are reluctant to invest in new technologies without assurances of equal or greater performance over extended periods of time. Thus manufacturers have been slow to develop new technologies in this area.

It has been unexpectedly found that polymeric materials, such as polyethylene teraphthalate (PET), surface treated polyethylene terephathalate(S-PET), QUIN-T, QUIN-TEK, polypropylene, polyethylene, polyethylene napthalate (PEN), polysulphones, polystyrene, polyimides, polyphenylene sulphide (PPS), polybutylene teraphthalate (PBT), polyamide imide (PAI), polyether imide (PEI), have long-term compatibility with the various hot mineral oils and other components of construction in oil filled electrical applications, such as oil filled transformers. These polymeric materials, used alone or in combination with paper materials, also provide higher thermal stability, higher dielectric breakdown strength of as much as or greater than 300%, lower water absorption, and greater structural strength over paper materials. These advantageous properties allow the reduction of insulation thickness for a given electrical application while maintaining equal or better dielectric performance. Reduced insulation thickness means that more space is available for other electrical components, such as copper conductor, thus allowing more power output for a given equipment size or decreased equipment size for the same power output. Furthermore, the lower water absorption properties of polymeric materials reduce the costs and process time associated with paper materials. Higher mechanical strength and low shrinkage of polymeric materials offer improved mechanical stability. Recent reductions in the cost of polymeric materials in relation to paper materials further contribute to the potential cost savings. Furthermore, new materials development with added functional additives/fillers into polymeric materials have significantly enhanced polymeric properties/performance.

The polymeric materials of the present disclosure can be utilized alone, in combination with other insulating materials, in layers, as films, coated, extruded, molded and any combinations thereof.

The insulation systems employing polymeric materials and devices including the insulation systems employing polymeric materials can be used to insulate any portion of an oil filled environment. In an oil filled environment, the insulation system is typically in contact with an oil. Examples of suitable uses for the insulation system include, but are not limited to, as main insulation for the windings of an electrical device, as layer insulation for the windings of an electrical device, lead insulation, end rings, and spacers. Examples of suitable oil filled environments include, but are not limited to, an oil filled transformer and transformer bushings. Examples of typical oils that the insulation system can come into contact with include, but are not limited to, mineral oil, silicone oil, vegetable oil, ester oil, synthetic oil, and any combinations thereof.

In one embodiment of the invention an insulation system for an oil filled environment includes a plurality of insulating units, each of the plurality of insulating units including a first layer of insulating material and a second layer of insulating material. At least one of the first and second layers includes a polymeric material. The insulating units are positioned with respect to each other such that the second layer of one insulating unit is adjacent to the first layer of another insulating unit.

A first layer and a second layer can make up an insulating unit. The insulation system may include a plurality of insulating units positioned with respect to each other such that a second layer of one insulating unit is adjacent to a first layer of another insulating unit. One example of an insulation system may have a paper first layer, a polymeric second layer, a paper first layer, a polymeric second layer, a paper first layer, a polymeric second layer, and so on. A plurality of insulating units may terminate at a terminal layer, the terminal layer having thereon a third layer of a paper insulating material. One example of the present disclosure may have a paper first layer, a polymeric second layer, a paper first layer, a polymeric second layer, and a paper third layer.

In one example, the plurality of insulating units is formed by winding a first layer and a second layer around itself such that in each winding the second layer is adjacent to the first layer of the last winding and so on. It should be noted that this example is one method of forming the plurality of insulating units and that any arrangement that gives a plurality of insulating units is suitable. Another suitable example would be individual first and second layers forming unique insulating units that are positioned adjacent to each other.

The polymeric material can be any polymeric material with insulating properties that has long-term stability in oil filled environments. Examples of suitable polymeric materials include, but are not limited to, polyethylene teraphthalate (PET), surface treated polyethylene terephathalate(S-PET), QUIN-T, QUIN-TEK, polypropylene, polyethylene, polyethylene napthalate (PEN), polysulphones, polystyrene, polyimides, polyphenylene sulphide (PPS), polybutylene teraphthalate (PBT), polyamide imide (PAI), polyether imide (PEI) and any combinations thereof. The polymeric material may be a polymeric film having a pattern thereon. In an embodiment the polymeric material is polyethylene teraphthalate (PET) based.

Both the first layer and the second layer may include a polymeric material. Alternatively, the layer that does not include polymeric material may include any other suitable insulation material. Examples of other suitable insulation materials include, but are not limited to, cellulose paper, fish paper, ceramic paper and any combinations thereof. Examples of suitable cellulose paper insulation materials include, but are not limited to, kraft paper, epoxy patterned paper, cellulose-composite paper, cellulose paper with glass cloth/polymer film backing and any combinations thereof. In an embodiment the paper insulation material is epoxy patterned cellulose paper.

The thickness of the first layer and the second layer may each be any thickness that minimizes the thickness while still providing required mechanical, structural, and dielectric properties. In one embodiment the thickness of the first layer and the second layer are each in the range of about 0.5 to about 20 mils [1 mil=25.4 micrometer]. In a further embodiment, the thickness of the first layer and the second layer are each from about 0.5 mil to about 10 mil. In another embodiment, the thickness of the first layer and the second layer are each from about 1 mil to about 6 mil. In yet another embodiment, the thickness of the first layer and the second layer are each from about 2 mil to about 6 mil. In still yet another embodiment, the thickness of the first layer and the second layer are each from about 3 mil to about 5 mil. For one example, the thickness of the first layer may be 3 mil and the thickness of the second layer may be 5 mil.

In an embodiment, the ratio of the thickness of the second layer to the first layer may be about 1:40 to about 40:1. In another embodiment, the ratio of the thickness of the second layer to the first layer may be about 1:10 to about 10:1. In yet another embodiment, the ratio of the thickness of the second layer to the first layer may be about 0.75:1.25 to about 1.25:0.75. In still yet another embodiment, the ratio of the thickness of the second layer to the first layer is about 0.5:1 to about 1.5:1. In a further embodiment, the ratio of the thickness of the second layer to the first layer may be about 1:1.

In one aspect of the present disclosure, the first layer may include paper insulation and the second layer may include a polymer material. Alternatively, both the first layer and the second layer include a polymer material. In a further embodiment, the insulation system may include only polymeric material.

In one aspect, it is believed that alternating polymeric material with paper insulation material provides for the use of less main insulation material while maintaining the same dielectric breakdown strength as a larger thickness of paper insulation material alone. This leads to further cost savings in the use of less copper and other magnetic materials. Further, the alternating materials help to distribute the dielectric stress throughout the insulation system. The paper insulation material is typically more readily impregnated by the oil of the oil filled environment than is the polymeric material. The alternating layers of paper insulation material allow for the proper impregnation of the oil throughout the insulation system while taking advantage of the higher dielectric breakdown strength of the polymeric materials. Proper impregnation of the oil can, in part, prevent large concentrations of dielectric stress in areas of air that may be trapped between layers. In another example, proper impregnation of the oil may be ensured by the use of polymeric materials that have patterns thereon. The patterns provide a roughness on the polymeric surface that allows for oil impregnation between adjacent polymeric layers. Mechanical strength may also be improved by the use of commercially available paper insulation materials that have epoxy patterns thereon which can be used to adhere the alternating polymeric and paper layers together.

In an embodiment, the percent polymer in the insulation system can be about 10% to about 100%. In another embodiment, the percent polymer in the insulation system can be about 30% to about 60%. In yet another embodiment, the percent polymer in the insulation system can be about 40% to about 50%. In still yet another embodiment, the percent polymer in the insulation system can be about 45%.

An insulation system can include any number of insulating units. For example, when the oil filled environment is an oil filled transformer, the number of insulating units can depend on the rating of the oil filled transformer.

In one example, an insulation system includes 7 insulating units, the first layer having a thickness of about 5 mil and the second layer having a thickness of about 3 mil. Alternatively, the insulation system may also have a third layer having a thickness of about 5 mil. The total thickness of the first, second, and third layers of this example is 61 mil.

In another example, an insulation system includes 5 insulating units, the first layer having a thickness of about 5 mil and the second layer having a thickness of about 5 mil. Alternatively, the insulation system may also have a third layer having a thickness of about 5 mil. The total thickness of the first, second, and third layers of this example is 55 mil.

In one aspect an oil filled electric device including an insulation system which includes a plurality of insulating units, each of the plurality of insulating units including a first layer of insulating material and a second layer of insulating material. At least one of the first and second layers includes a polymeric material. The insulating units are positioned with respect to each other such that the second layer of one insulating unit is adjacent to the first layer of another insulating unit.

In another aspect an oil filled transformer includes a main insulation system, which includes a plurality of insulating units, each of the plurality of insulating units including a first layer of insulating material and a second layer of insulating material. At least one of the first and second layers includes a polymeric material. The insulating units are positioned with respect to each other such that the second layer of one insulating unit is adjacent to the first layer of another insulating unit.

In yet another aspect an oil filled transformer includes a main insulation system, which includes a plurality of insulating units, each of the plurality of insulating units including a first layer of insulating material and a second layer of insulating material. All of the first and second layers includes a polymeric material. The insulating units are positioned with respect to each other such that the second layer of one insulating unit is adjacent to the first layer of another insulating unit.

In still yet another embodiment of the present disclosure an insulation system for an oil filled environment which includes a first layer of a polymeric insulating material, said first layer being selected from the group consisting of layer insulation, main insulation, spacer insulation, end rings and any combinations thereof.

The polymeric material can be any polymeric material with insulating properties that has long term stability in oil filled environments. Examples of suitable polymeric materials include, but are not limited to, polyethylene teraphthalate (PET), surface treated polyethylene terephathalate(S-PET), QUIN-T, QUIN-TEK, polypropylene, polyethylene, polyethylene napthalate (PEN), polysulphones, polystyrene, polyimides, polyphenylene sulphide (PPS), polybutylene teraphthalate (PBT), polyamide imide (PAI), polyether imide (PEI) and any combinations thereof. In an embodiment, the polymeric material is polyethylene teraphthalate (PET) based.

In an embodiment, the thickness of the first layer may be any thickness from about 0.5 mil to about 20 mil. In another embodiment, the thickness of the first layer is from about 1 mil to about 10 mil. In yet another embodiment, the thickness of the first layer is from about 3 mil to about 8 mil. In still yet another embodiment, the thickness of the first layer is from about 3 mil to about 6 mil. In a further embodiment, the thickness of the first layer is from about 3 mil to about 5 mil.

In a further embodiment of the present disclosure an insulation system for an oil filled environment includes a plurality of layers of insulating material, at least two of the plurality of layers comprising a polymeric material.

The polymeric material can be any polymeric material with insulating properties that has long term stability in oil filled environments. Examples of suitable polymeric materials include, but are not limited to, polyethylene teraphthalate (PET), surface treated polyethylene terephathalate(S-PET), QUIN-T, QUIN-TEK, polypropylene, polyethylene, polyethylene napthalate (PEN), polysulphones, polystyrene, polyimides, polyphenylene sulphide (PPS), polybutylene teraphthalate (PBT), polyamide imide (PAI), polyether imide (PEI) and any combinations thereof. In an embodiment, the polymeric material is polyethylene teraphthalate (PET) based.

In an embodiment, the thickness of each of the plurality of layers may be any thickness from about 0.5 mil to about 20 mil. In another embodiment, the thickness of each of the plurality of layers is from about 1 mil to about 10 mil. In yet another embodiment, the thickness of each of the plurality of layers is from about 3 mil to about 8 mil. In still yet another embodiment, the thickness of each of the plurality of layers is from about 3 mil to about 6 mil. In a further embodiment, the thickness of each of the plurality of layers is from about 3 mil to about 5 mil.

In one embodiment, the plurality of layers of insulating material include alternating layers of polymeric material and a paper insulating material.

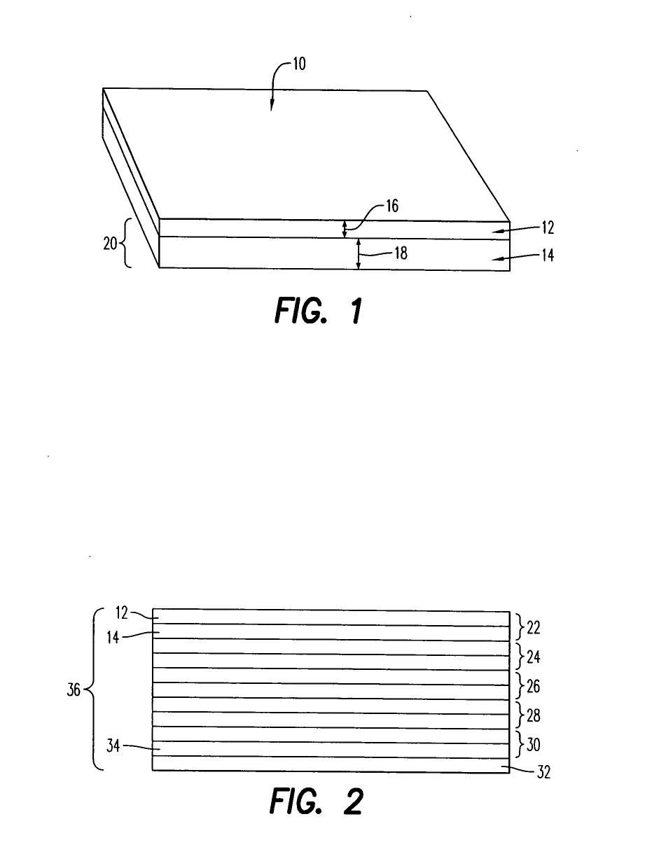

Referring now to the drawings and in particular to FIG. 1, an insulation system is illustrated by way of reference numeral 10. The insulation system 10 includes a first layer 12 with a thickness 16 and a second layer 14 with a thickness 18. The first layer and second layer make up an insulating unit. The insulation system 10 has a total thickness 20.

FIG. 2 shows an insulation system 16 having a plurality of insulating units 22, 24, 26, 28, and 30, and a third layer 32 adjacent to the terminal second layer 34 of the insulation unit 30. Each insulating unit includes a first layer 12 and a second layer 14. The insulation system 16 has a total thickness 36. It should be noted that although this one example shows five insulating units, an insulation system of the present disclosure may have more or less insulation units.

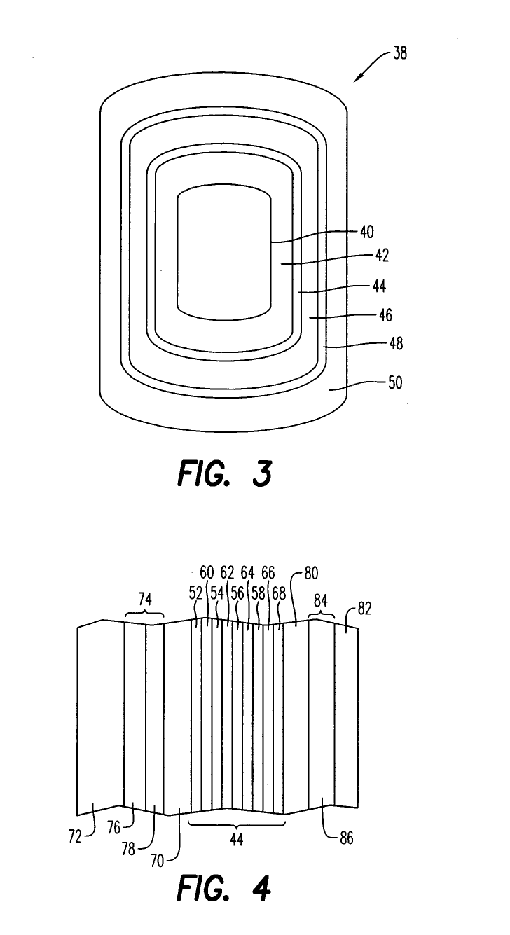

FIG. 3 shows an electrical winding 38 which includes a winding form 40, a first low voltage winding 42, a first main insulation 44, a first high voltage winding 46, a second main insulation 48, and a second low voltage winding 50. It should be noted that although this one example shows an electrical winding with a low voltage/high voltage/low voltage arrangement, an insulation system of the present disclosure may be part of a variety of electrical devices having a variety of components known in the art.

FIG. 4 shows a close up illustration of main insulation 44 which is illustrative of one example of an insulation system having first layers 52, 54, 56, and 58; second layers 60, 62, 64, and 66; and third layer 68. FIG. 4 also shows a first wind 70 and a second wind 72 of the first low voltage winding 42 with layer insulation 74. Layer insulation 74 includes first layer 76 and second layer 78. FIG. 4 also shows a third wind 80 and a fourth wind 82 of the first high voltage winding 46. Layer insulation 84 includes first layer 86. It should be noted that layer insulation and main insulation can be one layer of polymeric material, multiple layers of polymeric material, and/or a combination of a layer or layers of polymeric material and a layer or layers of other insulating material, such as paper.

It is possible to have a plurality of insulating units formed from a winding of one first layer and one second layer wound around themselves. In one embodiment, first layers 52, 54, 56, and 58 may be the same sheet of material, such as a paper insulating material, and second layers 60, 62, 64, and 66 may be the same sheet of material, such as a polymeric material. The first layer sheet of material and the second layer sheet of material are wrapped around each other such that a cross section of the windings reveals a plurality of insulating units each comprising one of the first layers (52, 54, 56, and 58) and one of the second layers (60, 62, 64, and 66).

### EXAMPLE 1

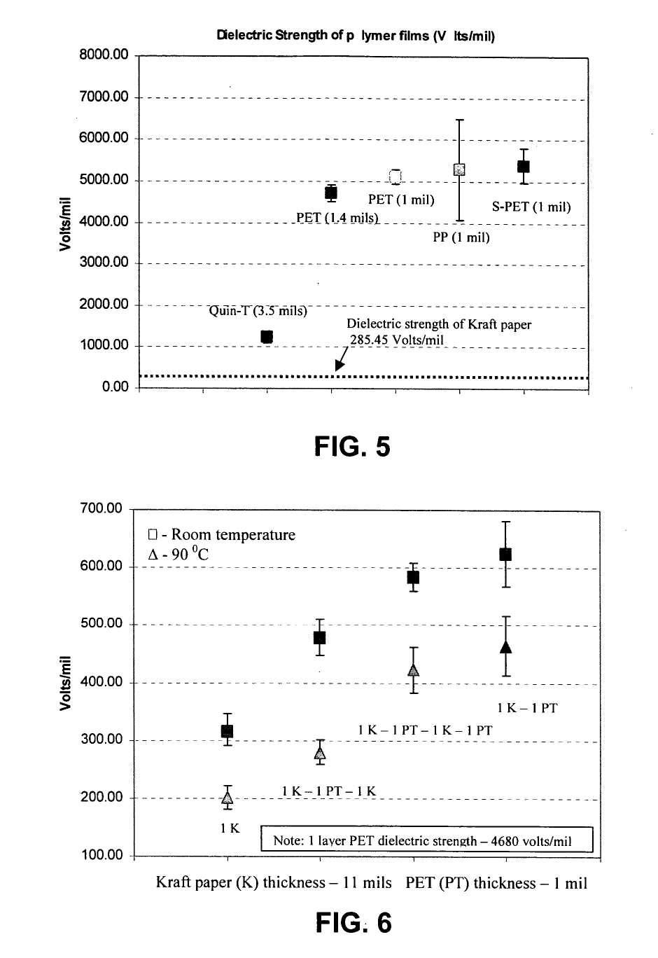

This example shows breakdown strength in volts/mil for several polymeric film insulation systems. The AC breakdown test was conducted in SF 97-50 GE Silicone oil at room temperature using top and bottom electrode diameter of 2″ and voltage ramp=0.2 KV/sec. FIG. 5 shows the AC breakdown strength for kraft paper, PET (25 micron), PET (36 micron), and S-PET (26 micron). This example shows an increase in AC breakdown strength for PET and S-PET over kraft paper.

### EXAMPLE 2

This example shows AC breakdown strength (volts/mil) for various combinations of epoxy patterned Kraft paper and polyethylene teraphthalate (PET). FIG. 6 shows the AC breakdown strength of various combinations tested in transformer oil at room temperature and 90 degrees Celsius. In FIG. 6, a Kraft paper layer is designated with a K and a PET film layer is designated with a PT. For example an insulation system having one Kraft layer, one PET layer, and one kraft layer is designated by 1K-1PT-1K. The PET film thickness used is 1 mil and Kraft paper thickness is 11 mil. The top electrode is a 1 inch diameter cylindrical electrode and the bottom electrode is a 3 inch diameter flat electrode.

This example shows the breakdown strength reduces as the constitution of epoxy patterned Kraft paper is increased.

### EXAMPLE 3

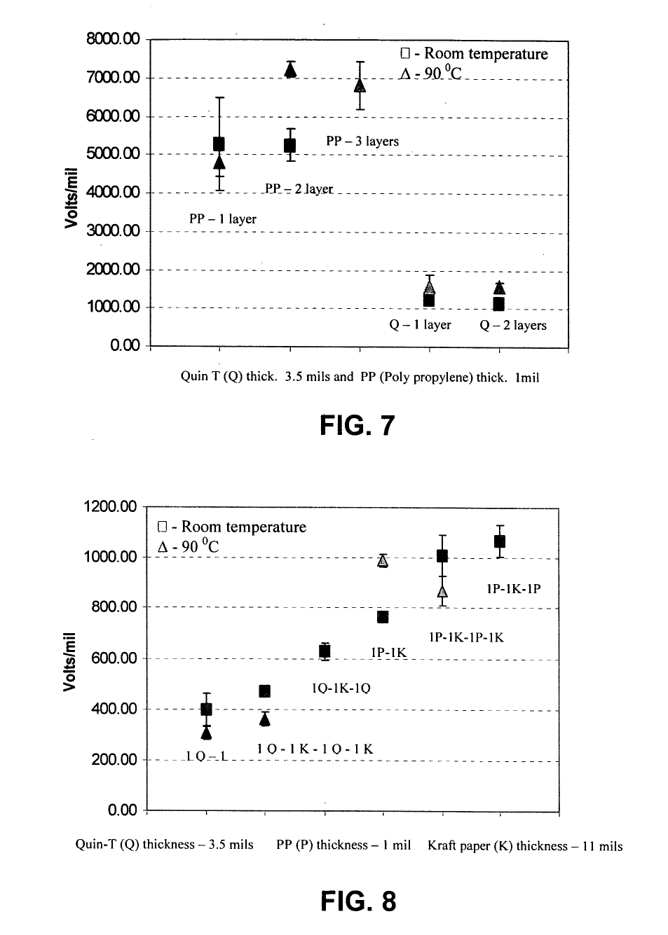

This example shows AC breakdown strength values in volts/mil for QUIN-T (Q) and polypropylene (PP) films. FIG. 7 shows AC breakdown strength values for single and multiple layers of QUIN-T and PP polymer films at room temperature and 90 degrees Celsius. FIG. 8 shows the AC breakdown strength (volts/mil) of QUIN-T and polypropylene films in combination with epoxy patterned Kraft paper at room temperature and 90 degrees Celsius.

This example shows that the breakdown strength of polypropylene (PP) is good both independently and in combination with epoxy patterned Kraft paper.

### EXAMPLE 4

This example compares the thermal aging performance conducted as per IEEE Standard C57.100-1999 on various combinations of polypropylene (PP)-epoxy patterned Kraft paper, QUIN-T-epoxy patterned Kraft paper, and polyethylene teraphthalate (PET)-epoxy patterned Kraft paper. Though the performance of polypropylene (PP)-epoxy patterned Kraft paper and QUIN-T-epoxy patterned Kraft paper combinations are satisfactory, the performance of polyethylene teraphthalate (PET)-epoxy patterned Kraft paper is found to be superior.

### EXAMPLE 5

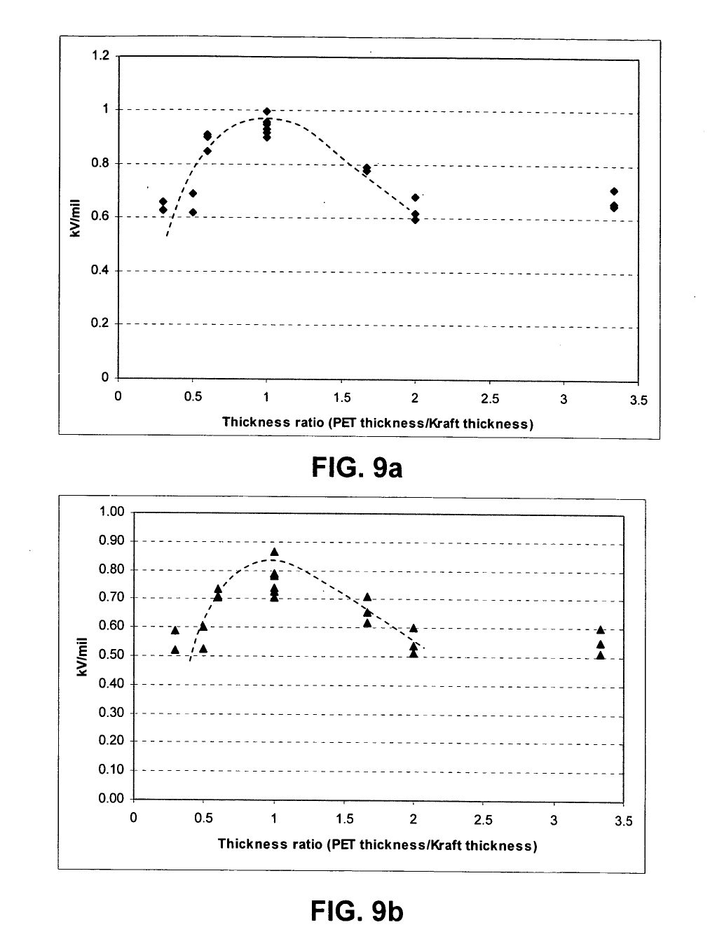

This example shows AC breakdown strength (kV/mil) of various combinations of polyethylene teraphthalate (PET) and epoxy patterned Kraft paper. FIG. 9 shows the AC breakdown strength (kV/mil) as a function of the ratio between the thickness of polyethylene teraphthalate (PET) and epoxy patterned Kraft paper: FIG. 9a shows room temperature performance and FIG. 9b shows the performance at 120 degree Celsius.

The higher breakdown strength (kV/mil) is obtained for the ratio of polyethylene teraphthalate (PET) and epoxy patterned Kraft paper thickness between about 0.5:1 to about 1.5:1. In another embodiment the ratio is about 0.8:1 to about 1.2:1. In yet another embodiment the ratio is between about 0.9:1 to about 1.1:1. In still yet another embodiment the ratio is 1:1.

### EXAMPLE 6

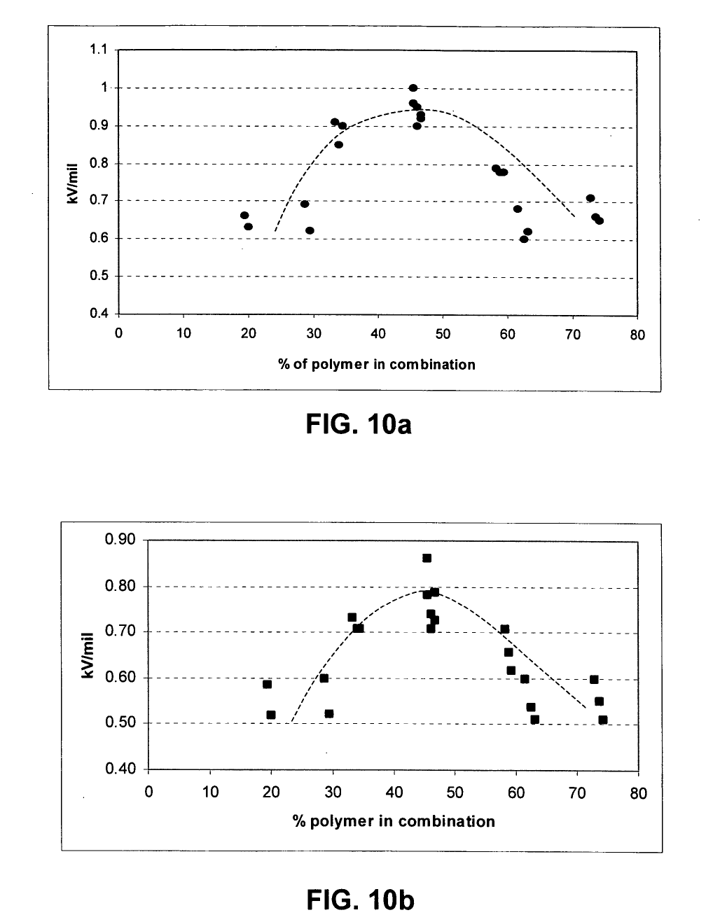

This example shows AC breakdown strength (kV/mil) of various combinations of polyethylene teraphthalate (PET) and epoxy patterned Kraft paper. FIG. 10 shows the AC breakdown strength (kV/mil) as a function of the percentage of polymer content in the combination of polyethylene teraphthalate (PET) and epoxy patterned Kraft paper: FIG. 10a shows room temperature performance and FIG. 10b shows the performance at 120 degree Celsius.

The higher breakdown strength is obtained for the polymer content (in percentage) for the combination of polyethylene teraphthalate (PET) and epoxy patterned Kraft paper, in the range of about 30% to about 70%. In an embodiment, the percentage polymer may be about 35% to about 55%. In another embodiment, the percentage polymer may be about 40% to about 50%.

AC breakdown strength (kV/mil) was compared to percent polymer in the system and polyethylene teraphthalate (PET) to epoxy patterned Kraft paper thickness ratio. This comparison highlights combinations of 3 mil polyethylene teraphthalate (PET)/3 mil epoxy patterned Kraft paper, 5 mil polyethylene teraphthalate (PET)/5 mil epoxy patterned Kraft paper, and 3 mil polyethylene teraphthalate (PET)/5 mil epoxy patterned Kraft paper as having higher AC breakdown strength (kV/mil).

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated for carrying out this disclosure, but that the disclosure will include all embodiments falling within the scope of the appended claims.

1. An insulation system for an oil filled environment comprising:
a plurality of insulating units, each of said plurality of insulating units comprising a first layer of insulating material and a second layer of insulating material;
at least one of said first and second layers comprising a polymeric material, said insulating units positioned with respect to each other such that said second layer of one insulating unit is adjacent to said first layer of another insulating unit.

2. The system of claim 1, wherein said polymeric material is selected from the group consisting of: polyethylene teraphthalate (PET), surface treated polyethylene teraphthalate (S-PET), QUIN-T, QUIN-TEK, polypropylene, polyethylene, polyethylene napthalate (PEN), polysulphones, polystyrene, polyimides, polyphenylene sulphide (PPS), polybutylene teraphthalate (PBT), polyamide imide (PAI), polyether imide (PEI) and any combinations thereof.

3. The system of claim 1, wherein said plurality of insulating units terminates at a terminal layer, said terminal layer having thereon a third layer of a paper insulating material.

4. The system of claim 1, wherein said first layer and said second layer each have a thickness from about 0.5 mil to about 20 mil.

5. The system of claim 1, wherein said first layer comprises a paper insulating material, and wherein said second layer comprises said polymeric material.

6. The system of claim 1, wherein said first layer has a first thickness and said second layer has a second thickness, a ratio of said second thickness to said first thickness is from about 0.75:1.25 to about 1.25:0.75.

7. The system of claim 1, wherein the system is selected from the group consisting of main insulation, layer insulation, and any combinations thereof.

8. The system of claim 1, wherein said plurality of insulating units is formed of a winding of said first and second layers.

9. An oil filled electric device comprising:
a plurality of insulating units, each of said plurality of insulating units comprising a first layer of insulating material and a second layer of insulating material, at least one of said first and second layers comprising a polymeric material, said insulating units positioned with respect to each other such that said second layer of one insulating unit is adjacent to said first layer of another insulating unit; and
oil in contact with said polymeric material.

10. The device of claim 9, wherein said polymeric material is selected from the group consisting of: polyethylene teraphthalate (PET), surface treated polyethylene teraphthalate (S-PET), QUIN-T, QUIN-TEK, polypropylene, polyethylene, polyethylene napthalate (PEN), polysulphones, polystyrene, polyimides, polyphenylene sulphide (PPS), polybutylene teraphthalate (PBT), polyamide imide (PAI), polyether imide (PEI) and any combinations thereof.

11. The device of claim 9, wherein said first layer and said second layer each have a thickness from about 0.5 mil to about 20 mil.

12. The device of claim 9, wherein said first layer has a first thickness and said second layer has a second thickness, a ratio of said second thickness to said first thickness is from about 0.75:1.25 to about 1.25:0.75.

13. The device of claim 9, wherein said plurality of insulating units forms a insulation system selected from the group consisting of main insulation, layer insulation, and any combinations thereof.

14. The device of claim 9, wherein said first layer comprises a paper insulating material, and wherein said second layer comprises a polymeric material.

15. The device of claim 14, wherein said plurality of insulating units is formed of a winding of said first and second layers.

16. The device of claim 9, wherein said plurality of insulating units terminates at a terminal layer, said terminal layer having thereon a third layer of a paper insulating material.

17. An oil filled transformer comprising:
a main insulation which comprises:
a plurality of insulating units, each of said plurality of insulating units comprising a first layer of insulating material and a second layer of insulating material;
at least one of said first and second layers comprising a polymeric material, said insulating units positioned with respect to each other such that said second layer of one insulating unit is adjacent to said first layer of another insulating unit.

18. The transformer of claim 17, wherein said first layer and said second layer each have a thickness from about 0.5 mil to about 20 mil.

19. The transformer of claim 17, wherein said first layer has a first thickness and said second layer has a second thickness, a ratio of said second thickness to said first thickness is from about 0.75:1.25 to about 1.25:0.75.

20. The transformer of claim 17, wherein said first layer comprises a paper insulating material, and wherein said second layer comprises a polymeric material.

21. The transformer of claim 20, wherein said plurality of insulating units terminates at a terminal layer, said terminal layer having thereon a third layer of a paper insulating material.

22. The transformer of claim 21, wherein said plurality of insulating units is formed of a winding of said first and second layers.

23. The transformer of claim 21, wherein said polymeric material is selected from the group consisting of: polyethylene teraphthalate (PET), surface treated polyethylene teraphthalate (S-PET), QUIN-T, QUIN-TEK, polypropylene, polyethylene, polyethylene napthalate (PEN), polysulphones, polystyrene, polyimides, polyphenylene sulphide (PPS), polybutylene teraphthalate (PBT), polyamide imide (PAI), polyether imide (PEI) and any combinations thereof.

24. The transformer of claim 23, wherein said first layer and said second layer each have a thickness from about 0.5 mil to about 10 mil.

25. The transformer of claim 24, wherein said first layer has a first thickness and said second layer has a second thickness, a ratio of said second thickness to said first thickness is from about 0.75:1.25 to about 1.25:0.75.

26. The transformer of claim 21, wherein said insulating system comprises 7 insulating units, and wherein said first layer has a thickness of about 5 mil, said second layer has a thickness of about 3 mil, and said third layer has a thickness of about 5 mil.

27. The transformer of claim 21, wherein said insulating system comprises 5 insulating units, and wherein said first layer has a thickness of about 5 mil, said second layer has a thickness of about 5 mil, and said third layer has a thickness of about 5 mil.

28. The transformer of claim 17, wherein said polymeric material is in contact with a transformer oil.

29. An insulation system for an oil filled environment comprising:
a first layer of polymeric insulating material,
said insulation system being an insulation selected from the group consisting of layer insulation, main insulation, spacer insulation, end rings and any combinations thereof.

30. The system of claim 29, wherein said polymeric insulating material is selected from the group consisting of: polyethylene teraphthalate (PET), surface treated polyethylene teraphthalate(S-PET), QUIN-T, QUIN-TEK, polypropylene, polyethylene, polyethylene napthalate (PEN), polysulphones, polystyrene, polyimides, polyphenylene sulphide (PPS), polybutylene teraphthalate (PBT), polyamide imide (PAI), polyether imide (PEI) and any combinations thereof.

31. The system of claim 29, wherein said first layer has a thickness from about 1 mil to about 20 mil.

32. The system of claim 39, wherein said insulation system is layer insulation.

33. An insulation system for an oil filled environment comprising:
a plurality of layers of insulating material, at least two of said plurality of layers comprising a polymeric material.

34. The system of claim 33, wherein said polymeric material is selected from the group consisting of: polyethylene teraphthalate (PET), surface treated polyethylene teraphthalate (S-PET), QUIN-T, QUIN-TEK, polypropylene, polyethylene, polyethylene napthalate (PEN), polysulphones, polystyrene, polyimides, polyphenylene sulphide (PPS), polybutylene teraphthalate (PBT), polyamide imide (PAI), polyether imide (PEI) and any combinations thereof.

35. The system of claim 33, wherein each of said plurality of layers of insulating material has a thickness from about 0.5 mil to about 20 mil.

36. The system of claim 33, wherein said plurality of layers of insulating material comprise alternating layers of said polymeric material and a paper insulating material.
